(19) United States
(12) Patent Application Publication
(10) Pub. No.: US 2025/0078680 A1
(43) Pub. Date: Mar. 6, 2025

(54) USER-FRIENDLY LANGUAGE-LEARNING PROCESS WHICH PROMOTES IMMEDIATE READING AND SPEAKING OF NEW LANGUAGES

(71) Applicant: Donald Patrick Bickerdike, Tucson, AZ (US)

(72) Inventor: Donald Patrick Bickerdike, Tucson, AZ (US)

(21) Appl. No.: 18/460,163

(22) Filed: Sep. 1, 2023

(51) Int. Cl. G09B 19/06

(52) U.S. Cl. CPC G09B 19/06

(57) ABSTRACT

The present invention is a user-friendly process and design which allows a learner to immediately begin reading and speaking a new language without the prerequisite of memorizing letters/characters or language vocabulary. Instructions for two-syllable (analog style) “clock-face” letters can be as simple as reading or speaking the sound indicated by the short line, then by adding the sound indicated by the longer line. This invention works by using a “clock-face” letter surrounded by a new language's phonetic sounds which are sequentially identified to create the correct order of speaking those sounds. The learner begins by reading and pronouncing the syllabary and then advances toward reading and speaking words and phrases for the new language. Advanced students can learn a unique shorthand-cursive-style writing system for the new language. The user-friendly cues help the learner to immediately begin reading and speaking the targeted language without requiring advanced skills or memorization.

The present utility patent amendment is related to the design patent application Ser. No. 29/915,586, filed on Nov. 1, 2023, for a clock-face font design with language notations. The design patent application discloses the overall design and appearance of the clock-face font, while the present utility patent amendment focuses on the functional aspects and nuance notation system that enables the font to accurately represent the nuances of languages with tonal and sound characteristics.

### BACKGROUND OF THE INVENTION

The copyright notice in this application does not necessarily constitute a waiver of any applicable copyright, nor does it necessarily constitute an admission that the application is not entitled to protection under the copyright laws of the United States.

### FIELD OF THE INVENTION

The present invention is in the field of Education and language technology. It falls under a category of language learning technology as it focuses on creating innovative methods and tools to improve language learning experiences. The present invention contributes to the development of visual language learning tools. These tools leverage visual representations and cues to make language learning more intuitive, engaging, and effective. The present clock-face font design and nuance notation system provide a unique and promising approach to representing tonal and sound nuances in languages, which can be challenging for learners to grasp using traditional text-based methods. In summary, the present clock-face font invention has the potential to revolutionize language learning by providing a more visual, consistent, and adaptable approach to representing language nuances. This innovation aligns with the broader goals of language technology to enhance language learning outcomes and promote linguistic diversity.

### Problems to be Solved

As referenced by Herrick et al. (2015), the current population of speakers and learners do not have clear intuitions about Cherokee tones:

“The current population of speakers and learners do not have clear intuitions about Cherokee tones, and neither the standard romanizations nor the Syllabary offers information about tone. A learner encountering new words must consult Pulte & Feeling (1975), and if the new word is not listed in this (relatively small) dictionary, then the only option to discover the proper tone is to find a fluent speaker to pronounce the word. This is a great problem because unless learners have access to a fluent speaker, pronunciation is likely to suffer since it is impossible to know the correct tone and vowel length for new vocabulary based solely on either writing system (Hinton 2001)” (Herrick et al., 2015).

The Cherokee language is an endangered language, and there is a need for new and innovative methods to preserve it by using an invention which combines the nuances of a Native Cherokee Speaker within a unique syllabary writing system (which has never before been accomplished prior to this present invention.) Current methods of teaching the Cherokee language often separate the Cherokee symbols (Syllabary) from the (vague) English version/transliteration of representing the sounds (the standard transliteration). This can make it difficult for learners to connect the two languages (the Cherokee Syllabary and the written transliteration) making it difficult to correctly associate sounds with the corresponding characters, which can lead to frustration and a loss of motivation.

The Cherokee language is a syllabary, meaning that each character represents a syllable. This makes it a challenging language for native English speakers to learn, as Cherokee syllabary characters do not correspond directly to English letters (even though several Cherokee characters “appear” to resemble English/Latin letters.) This perception of difficulty is likely due to the fact that the Cherokee language is considered to be a Class IV language (Cherokee Nation Language Department, 2023).

The present invention is a new and novel method for teaching the Cherokee language that integrates transliteration and notations (the correct sounds and language nuances) into (and intertwined with) the written form of the Syllabary (the written characters which represent the syllable sounds). This approach is designed to make it easier for learners to connect the correct sounds with the syllabary characters and to reduce the perception of the Cherokee language as being difficult to learn.

The present invention is also designed to be easy to use and accessible to all Cherokee citizens. This is important because the Cherokee language is an important part of Cherokee culture and identity, and all Cherokee citizens should have the opportunity to learn their native language.

The present invention is a significant advance in the field of Cherokee language preservation. It has the potential to revitalize the Cherokee language and to ensure that it is passed down to future generations.

The inventor of the present invention appreciates this need for a current, updated, and enhanced version and presentation of the Cherokee Syllabary and language which is designed to exponentially expand the use of the Cherokee language.

Learning a new language can be a daunting task, especially when past and current methods do not allow students/learners to immediately begin correctly pronouncing the new language (based upon reading and speaking the language in the written form), and also when the language is considered to have a higher level of difficulty.

There is not an obvious logical association between the Cherokee symbols/characters and the correct corresponding sounds. Past methods of teaching languages often required extensive repetition to memorize the phonetic sounds and nuances which are associated with the new language which can be a tedious method. Past methods of teaching a new language often focuses on learning from native speakers of the new language while not addressing the entire needs and perspectives of the English-speaking learner. The inventor is a native-English speaker, is a Cherokee Citizen of the Cherokee Nation, and is also related to Sequoyah, the inventor of the Cherokee syllabary. In the past, there has not appeared to be a revolutionary standard for learning languages which can allow the learner to immediately begin reading and speaking a new language such as the Cherokee language. This invention addresses the above issues and provides logically arranged steps to ensure the correctly ordered pronunciation.

### DESCRIPTION OF PRIOR ART

The Related Art which addresses the most similar issues compared to the present invention is Durbin Feeling's 1975 Cherokee Dictionary. Other Prior Art (Suzuki et al., 2013) demonstrates an effort to identify sounds for all languages and then represents these sounds in the form of various symbols; this is in large contrast to the present invention which uses an extended transliteration (into the English language which is based upon the student/learner having familiarity with these sounds in the English language) as being the common factor for all sounds in reference to all second languages being learned as associated with characters/symbols and nuance notations.

Prior Art, Item 1: Durbin Feeling's 1975 Cherokee Dictionary, cited as:

Feeling, Durbin, and William Pulte. Cherokee-English Dictionary (pp. vii-355). Cherokee Nation of Oklahoma, 1975.

Durbin Feeling's 1975 Cherokee Dictionary is a comprehensive guide to the Cherokee language. The dictionary provides definitions of Cherokee words, grammatical rules, and examples of usage.

The dictionary is relevant to the present invention because, as a standard for learning the Cherokee language, it does not fully resolve the problems which still exist. While Durbin Feeling used his own notation references for some syllable lengths and most tones, Feeling's process differs from the present invention in the following ways: Feeling did not show notations for the last syllable of Cherokee words, he did not show notations for the middle length/duration syllable, he did not use a notation system which would visually show the rising and falling of tones, he did not use a notation system which showed the visual representation of the duration of syllables (which would otherwise show consecutive symbols to represent lengths and duration), he did not integrate each of the transliterations/syllable sounds to each of the Cherokee Syllabary characters into one font system, and he did not invent a shorthand version of the syllabary.

While Durbin Feeling's 1975 Cherokee Dictionary did not fully include or address the above mentioned items, the present invention has successfully addressed and implemented all of the above mentioned items.

The present invention addresses the shortcomings of all previous forms of written representation of the Cherokee language by the present invention using the clock-face fonts which identify the correct transliterated syllable sounds for each character which correlate to the Cherokee Syllabary characters, and the present invention also uses the language nuance notations (the tonal-nuance notations and the duration-nuance notations) to represent the tone patterns, tone changes, and syllable durations for all of the syllables in Cherokee words and phrases; the present invention offers to correctly identify the authentic sounds and nuances of the Cherokee language in full while using the Cherokee syllabary characters, which is a big advancement over previous efforts to document all the correct and authentic Cherokee language in written form (whereas past systems failed to fully document the language nuances in a visually represented form in contrast to the present invention which has 100% accomplished this endeavor.)

Prior Art, Item 2: Titled, “Methods and systems for transcribing or transliterating to an iconophonological orthography” cited as:

Suzuki, M. d. S., Hamilton, D. J., & Suzuki, E. M. (2013). Methods and systems for transcribing or transliterating to an iconophonological orthography. U.S. Provisional Patent Application No. 2013/0191115 A1, filed Nov. 3, 2011 and published Jul. 25, 2013.

The above mentioned provisional patent application discloses methods and systems for transcribing or transliterating a language to an iconophonological orthography. An iconophonological orthography is a system of writing that uses icons or symbols to represent sounds. The disclosed methods and systems can be used to transcribe or transliterate a language to an iconophonological orthography in order to improve literacy, communication, and language learning. The symbols/shapes and linguistic references used in the above mentioned provisional patent application help to create a consistent representation of language sounds while focusing on tongue, mouth, and jaw orientations with different aspirations to associate with geometrical shapes, symbols, or various linguistic notations to represent these sounds (Suzuki et al., 2013).

The present invention, in contrast to the above provisional patent, uses transliterated English letters to represent the sounds of the targeted language; these letters are uniquely grouped and arranged around the clock-face styled font while using lines, colors, and notations to identify and teach the specific sound/language nuances (the tonal-nuances and the duration-nuances) to facilitate faster learning and recognition.

For example, the present invention uses English letters which are already known and understood by the English-speaking student/learner, and therefore the present invention does not require any memorization of any geometrical symbols/shapes (or any other symbols) because the English letters identify the sounds while displaying the associated Cherokee Syllabary character, thereby making the present invention much easier to universally use for learning all second languages.

The present invention's clock face font-styled approach offers advantages in terms of clarity, efficiency, and ease of use because it uses familiar visual references to identify and teach the correct sounds of the targeted language.

In contrast to the above mentioned provisional patent, the present invention is easy to use and incorporates the knowledge that the student/learner already knows (the English language.)

Unlike the above provisional patent, the present invention is not complicated to implement for learning how to correctly speak the Cherokee language. The present invention easily identifies the correct sounds in a visual way and easily identifies tones and syllable lengths in a visual way while using known information (English letters, numerals, hyphens, and colors.)

The present invention is also easy to reduplicate by using a standard computer keyboard, using a specialized font to use the numerals (1-4) to represent tones, and use the hyphen to represent syllable lengths, as well as color-coding specific syllable segments in the color orange (if so desired or needed) to represent the “softer” consonant sounds. While this invention's design of the clock-face letters are novel, this invention was designed in a way to make it versatile for reduplicating much of the process in a transliterated form by easily using a standard keyboard (which can fully be accomplished when students/learners install the clock-face font in place of typing the transliterated English letters.)

The present invention also has the visual clock-face font style to use as references for teaching each unique Cherokee Syllabary symbol. For example, a class instructor can help students/learners in a classroom by referencing, “This Cherokee Syllabary symbol is represented by the time of 11:02 on our clock-face template” or by stating that “the short hand points to the 57 minute mark while the long hand points to the 2 minute mark”, both which can assist with the learning process.

The present invention is designed to be accessible by every Cherokee citizen for education and instruction in learning how to speak the authentic Cherokee Language through this invention's unique written form as part of the restoration of the Cherokee Nation as well as the revitalization of the Cherokee language and culture. The present invention allows for 100% of the Cherokee nation to learn how to speak the authentic Cherokee language.

### SUMMARY OF THE INVENTION

While certain languages may pose a learning challenge for English speakers due to their seemingly complex or intricate writing systems, this invention introduces a novel approach that simplifies letter representation. By combining clock-face symbols, line and arrow cues, and phonetic references, this invention creates a unique and logically structured system for each letter, transforming otherwise challenging characters into user-friendly representations. This is how the inventor has bridged the gap of understanding with this invention.

The present invention discloses novel clock-face fonts and language nuance (tonal nuance and duration-nuance) notation indicator systems designed to enhance the representation, documentation, and accessibility of the authentic Cherokee language. These original font designs, when used simultaneously, represent the authentically spoken Cherokee language, incorporating language nuance notations (to represent tonal/melodic pattern elements and to capture the tonal patterns, syllable sounds, syllable lengths, and intonation patterns and characteristics of the language.) The consistent and predictable structure of the fonts caters to the learning preferences of logically-oriented individuals, while also serving as a valuable tool for language preservation and documentation.

The present invention's unique combination of clock-face letters and shorthand-cursive-style characters enables students/learners to quickly grasp the sounds and symbols of a new language, leading to improved pronunciation and comprehension.

### Key Features

Original clock-face-styled font designs for the Cherokee language.

Integration with language nuance indicators (tonal-nuance notation indicators to identify and represent tone changes, tonal patterns, intonation, and melodic notation elements; and also duration-nuance notation indicators to identify and represent syllable lengths/durations.)

Enhanced engagement and accessibility of the Cherokee language.

Tailored to the learning preferences of logically-oriented individuals (such as individuals with Autism Spectrum Disorder/ASD, individuals with Asperger's Syndrome, individual with high IQ, individuals with certain logically-oriented personality traits.)

Valuable tool for language preservation and documentation.

Grounded in the linguistically accurate and culturally authentic Cherokee language.

Employs distinct symbols to capture the subtle variations in pronunciation, including tonal patterns, intonations, nuanced inflections, and syllable durations.

### Applications

Cherokee language learning materials (such as within primers, e-Books, apps, printed books, dictionaries, flashcards, placemats, websites, videos, clock-face fonts, workbooks, overhead projectors, online apps, etc.; the clock-face designs can be physically embodied as a printed poster, a digital display on a tablet or computer screen, or even a tactile surface with raised symbols for learners with visual impairments.) which can also be applied to other languages, including endangered languages.

Cherokee language documentation and preservation (such vocabulary databases, dictionaries) which can also be applied to other languages including endangered languages/languages which are being threatened with extinction.

Communication and information dissemination for Cherokee Nation citizens; this invention can be applied to other languages, including use for other tribes which similarly have endangered languages.

### Benefits

Improved representation and preservation of the Cherokee language (which can also be applied to other endangered languages.)

Enhanced accessibility and engagement for Cherokee language learners (which can also be applied to other languages, including endangered languages.)

Tailored learning approach for logically-oriented individuals (ASD, Asperger's, high IQ, logical personality), which can also be applied to other languages, including endangered languages.

Preservation of Cherokee cultural heritage (which can also be applied to other languages, including endangered languages.)

As the present invention is applied to all endangered languages: enhanced language learning, accurate pronunciation, language preservation, vocabulary expansion, existing word enhancement, and database and dictionary enhancement.

### Additional Benefits

The present invention's unique combination of clock-face letters and shorthand-cursive-style characters enables students/learners to quickly grasp the sounds and symbols of a new language, leading to improved pronunciation and comprehension after taking into consideration each language's unique structure, rules, and language nuances.

This invention is logically arranged and maintains a logical series of steps to identify any and all associated sounds and nuances of the second language.

This invention is also tailored to color vision deficiency individuals because they can still identify the correct order of phonetic sounds based on all of the cues/indicators for each clock-face. For example, in the Cherokee language the correct sounds can be deduced by color vision deficiency individuals by first identifying the short line's arrow (which points toward a specific phonetic sound), and then identifying the ending phonetic sound based on which phonetic sound the long line's arrow points toward.

The present invention for learning a new language associates the correct phonetic sound (or sounds) for unique clock-face letters to establish a logical anchor for each unique letter (symbol, character, glyph.) This invention includes the shorthand-cursive-style invention (displayed in the lower-right-hand corner of each clock-face font) and this shorthand/cursive-style character font process can be applied toward any language (the shorthand/cursive-style character font process follows the angles of the larger clock-face lines beginning with the shorter line and transitioning to the longer line.)

This invention can be applied to the full extent for any language to address all aspects of each language. Also, this invention includes the options of adjusting or modifying the clock-face tone and grades of colors. For example, a Journal of Vision article identified that the colors yellow and orange are the top two most visible colors for people with color deficiencies (Cole & Hagner, 2013), and therefore, changing certain Cherokee syllabary characters to the color orange (to therefore identify specific characters as being “soft” sounds such as indicating the “gah” sound versus the “kah” sound) is a color that is more likely to be seen in a clock-face font by people with color deficiencies. This is much like the English language for letters such as “c” as in “cat” versus the “c” as in “cinema.” Several of the Cherokee characters have a “hard” sound and a “soft” sound. While most language learning requires that a student/learner is expected to learn the difference by hearing the language, this invention uses visual cues to the fullest advantage. Therefore, using the color “orange” to indicate the “softer” of two sounds for the same character such as “gwah” versus “quah”) further enables this invention to provide all of the correct speech nuances of the Cherokee language.

This invention is versatile in that it can be modified in visual presentation to accommodate certain special needs of all or portions of the population; also the clock-face designs can be physically embodied as a printed poster, a digital display on a tablet or computer screen, or even a tactile surface with raised symbols for learners with visual impairments. The present invention provides a process which associates the correct phonetic sounds with a specific letter (symbol, character, glyph) in the targeted language. The present invention uses steps which are designed to be logical and efficient toward learning a new language's syllabary.

The individuals who have been introduced to the present invention and instructed how to use this present invention (who had no prior knowledge of the language being introduced to them) were briefly instructed on how to use the clock-face letters and then were able to quickly identify the correct phonetic sounds associated with the specific (and corresponding) characters in the targeted language's syllabary.

The present invention is designed to increase the number of people who learn new languages and it is also designed to preserve and save all languages for which this invention is applied toward.

### BRIEF DESCRIPTION OF DRAWINGS

The provided drawings illustrate various aspects of the present design and are a part of the specification. The illustrations are provided as examples and do not limit the scope of the disclosure.

FIG. 1 shows a front-view (in the same manner that a person would read a font on a computer screen or in a book) of the Cherokee clock-face letter for the Cherokee Syllable “wah” sound. This is an example of how this design is applied to the Cherokee language, however, this design can be applied to several endangered languages. FIG. 1 is an illustrative example of the clock-face letter design for the Cherokee language syllable sound of “wah.” FIG. 1 uses Reference Characters (numerals) and Lead Lines as described below in reference to FIG. 1 to further describe the characteristics of this design system:

Reference Character 101: The phonetic/transliterated sounds are referenced (displayed around the outer ring) which have been: transliterated into English letters, ordered in a “clock-wise” circle, and grouped according to the correlating sounds in the English language/alphabet (primarily displayed in alphabetic order.)

Reference Character 102: The short, green-highlighted line/arrow is referenced (which points toward the first Cherokee sound for this Cherokee character.)

Reference Character 103: The first (Cherokee) phonetic sound is referenced as the transliterated “w” sound (based on identifying where the short, green-highlighted arrow is pointing.)

Reference Character 104: The long, red-highlighted line/arrow is referenced (which points toward the second Cherokee sound for this Cherokee character.)

Reference Character 105: The second phonetic sound is referenced as the transliterated “ah” sound (based on identifying where the long, red-highlighted arrow is pointing.)

Reference Character 106: The Cherokee character is referenced as displayed in the middle of the larger clock-face.

Reference Character 107: The shorthand-cursive-style symbol (shown within the smaller clock-face which is located in the lower right-hand corner of the larger clock-face letter.) The shorthand/cursive-style design is based on the pattern from the lines/arrows in the larger clock-face.

FIG. 2 shows an example of how the clock-face letters are displayed to the student/learner within training material such as within primer books (which includes the additional five lines of information.) This image (FIG. 2) represents a page taken from the inventor's introductory Primer referencing the Cherokee word “wah-doh” (“thank you.”) This image shows the clock-face letters for the Cherokee word “wado” (“thank you”) whereas the clock-hands uniquely show the equivalent time of “11:02” (or more specifically, “the short hand points to the 57 minute mark while the long hand points to the 2 minute mark”) for the first Cherokee Syllabary character for the “wah” sound and the clock-hands uniquely show the equivalent time of “1:37” (or more specifically, “the short hand points to the 37 minute mark while the long hand points to the 7 minute mark”) for the second Cherokee Syllabary character for the “doh” sound. This Primer page also shows the translation, the standard English transliteration, the inventor's Extended transliteration, and additional notes which show the language nuances (the tonal-nuances and the duration-nuances) for the Cherokee Syllabary character's tones and syllable lengths which are visually displayed with the nuance indicators (specialized numerals and hyphens) and which is also displayed as a melody on sheet music for this word.

FIG. 3 uses Reference Characters to identify the five additional lines more specifically as would be shown within an introductory Primer book/e-book (FIG. 3 represents a page taken from the inventor's introductory Primer referencing the Cherokee word “wah-doh”/“thank you”) which is further described as follows:

Reference Character 301: The first line underneath the (Cherokee) clock-face characters identifies the English translation of the letters, words, and phrases from the targeted language.

Reference Character 302: The second line shows an example of the targeted language's unique letters (symbols, characters, glyphs) in order to separately identify the structure of each unique letter (symbol, character, glyph) separately from the clock-face template, lines, and arrows.

Reference Character 303: The third line displays the original/standard English transliteration of the targeted language. This line is included to show the contrast between the standard English transliteration and the inventor's Extended transliteration, whereas the standard English transliteration does not specifically identify all of the nuances (of the tonal-nuances and all of the duration-nuances) of the Cherokee language while in contrast the Extended transliteration does specifically identify the nuances (of the tonal-nuances and all of the duration-nuances) of the Cherokee language.

Reference Character 304: The fourth line identifies this invention's pronunciation cues by using the inventor's extended format, which is an extended written form within this invention which uses English letters (along with bold text to identify stressed syllables as needed along with the language nuance indicators) to specifically identify variances in pronunciation for the targeted language. For example, “bold text” can be used to identify the “harder” versus the “softer” stressed sounds for the same Cherokee Syllabary character (such as the harder “quah” sound versus the softer “gwah” sound.)

Reference Character 305: The fifth line is reserved for additional brief descriptions as needed in reference to unique information or language nuances. This section includes additional notes which show the language nuances (the tonal-nuances and the duration-nuances) for the Cherokee Syllabary character's tones and syllable lengths which are visually displayed with the language nuance indicators (tonal-nuances in the form of specialized numerals and duration-nuances by using hyphens) and which is also displayed as a music notation/melody on sheet music for this word.

FIG. 4 shows an example of how a database compilation appears on a spreadsheet (as taken from the inventor's database) which includes showing the headings for “Cherokee” (representing the Cherokee Syllabary spelling of each word/phrase), “Translation” (representing the English translation of the Cherokee word/phrase), the “Tone Pattern” (which is the tone sequence which is identified with special numerals and then used to document similarities among Cherokee words and is also used in combination with the “Syllable Lengths” to create the sheet-music/melody), “Syllable Lengths” (which is the syllable length sequence which is identified with a series of hyphens and then used to identify and document similarities among Cherokee words and is used in combination with the “Tone Patterns” to create the sheet-music/melody), and shows the syllable characters, syllable tones, and syllable lengths by using the clock-face letters and language nuance notations (the tonal-nuances and the duration-nuances) for each word/phrase. Color images in databases, dictionaries, and other educational materials would show any “orange” fonts used to identify the “softer” sound versions of certain Cherokee Syllabary characters. The smaller clock-face fonts are used and referenced after a student/learner has already become familiar with the correctly associated sounds for each of the Cherokee Syllabary characters, and therefore the smaller fonts (and smaller lines and arrows) represent a reminder for how to correctly read and speak each Cherokee syllable.

FIG. 5 is a comparison chart using the Cherokee Syllabary character which represents the “oh” sound as identified by various forms of notations which are meant to further identify the tones that can be used for this syllable. The present invention, the Clock-face font (which includes the shorthand font), and notations are the only references on this comparison chart which integrate a visual representation of the correct sounds and tones for each Cherokee syllable, which has never before been invented and therefore this is a further example of the present invention being a novel invention. This chart is based upon the original chart presented by Herrick et al. (2015) (Herrick et al., 2015). The original chart did not include this invention's clock-face designs or notations, however, this chart (FIG. 5) has been modified/upgraded to include this invention's clock-face designs and notations. The top left corner of the chart shows an enlarged view of the clock-face font design for the syllable sound “oh”. The headings indicate the possibilities for short duration and long duration vowel sounds with different tones and are labeled as: Short-Mid, Short-High, Long-Mid, Long-High, Long-Super-high, Long-Low-fall, Long-Falling, and Long-Rising. Further details for FIG. 5 are as follows:

In FIG. 5, Row 1 represents the clock-face letter for the “oh” sound. The first row (Bickerdike Clock-face) represents the Cherokee clock-faces with the language nuance notations (the tonal-nuances and the duration-nuances) using a specially designed numeric font which incorporates a visual black circle which rises and falls between a column of lines as the numerals go higher or lower, and also uses hyphens to identify whether the syllable has a short duration or a long duration. This row identifies all of the nuances (the tonal-nuances and the duration-nuances) of the Cherokee pronunciations in written form (the same process which is used for all of the characters/syllables in Cherokee words and phrases.) This row is easy to use and shows the complete and accurate Cherokee language sounds and nuances because it incorporates the extended transliterated sound references around the clock-faces and visually measurable notations for tones and durations/lengths of syllables.

In FIG. 5, Row 2 uses this invention's extended transliteration (the Bickerdike Transliteration) which more elaborately demonstrates the correct sound of “oh” to use and also the correct durations of the syllable, through this extended transliteration design. This row (in addition to row 1) also identifies all of the nuances (the tonal-nuances and the duration-nuances) of the Cherokee pronunciations in written form (the same process which is used for all of the transliterated characters/syllables for Cherokee words and phrases.) This row is easy to use and shows the complete and accurate Cherokee language sounds and nuances because it incorporates the extended transliterated sound references in English letters and visually measurable notations for tones and durations/lengths of syllables.

In FIG. 5, Row 3 represents the shorthand letter for the “oh” sound. This row (Bickerdike shorthand) represents the Cherokee shorthand with the language nuance notations (the tonal-nuances and the duration-nuances) using a specially designed numeric font which incorporates a visual black circle which rises and falls between a column of lines as the numerals go higher or lower to visually represent rising and falling tones, and also uses hyphens to identify whether the syllable has a short duration (one hyphen), medium duration (two hyphens) or a long duration (three hyphens). This row identifies all of the nuances (the tonal-nuances and the duration-nuances) of the Cherokee pronunciations in written form (the same process which is used for all of the shorthand syllables for Cherokee words and phrases.) This row is easy to use and shows the complete and accurate Cherokee language sounds and nuances because it incorporates the extended transliterated sound references around the clock-faces and visually measurable notations for tones and durations/lengths of syllables.

In FIG. 5, Row 4 represents the Cherokee Syllabary character for the “oh” sound, however, this row does not identify what the correct associated sound or syllable length is for each character, which can lead to the student/learner not knowing/learning the correct associated sounds and syllable lengths that this row represents.

In FIG. 5, Row 5 uses the Standard Romanization Anderson representation for the transliterated “oh” sound, however, there are no indications in this row as to whether or not the vowel is a short vowel, such as whether the sound has a short vowel (as in the English word “ox”) or a long vowel sound (as in the English word “oat”.)

In FIG. 5, the remaining rows (Rows 6, 7, 8, and 9) have notation systems for identifying short and long vowels and tones, however, these notations are not easily understood without further study and training and are “not visually measurable” notations which visually/measurably represent the tones and length of syllables. Unless a student/learner takes additional time to first study and then memorize these notations, learning the correct and authentic Cherokee pronunciations and nuances for tones and syllable durations/lengths cannot be fully accomplished in a visual presentation through these methods alone. In addition, the most commonly used method (Pulte & Feeling) does not provide a numeral (superscript) to identify the tones for the final syllables of Cherokee words and also does not identify all of the syllable lengths (Pulte & Feeling), leaving the tone patterns incomplete and without a visually measurable method.

### DETAILED DESCRIPTION OF THE INVENTION

The present invention, encompassing both a process and a composition of matter, introduces a revolutionary method for teaching new languages, particularly endangered languages like Cherokee. At the heart of this invention lies a unique clock-face character design used for each character within a syllabary, a visual representation of the syllabary characters used with a unique visual representation of tonal/melodic patterns and syllable durations through language nuance notations (the tonal-nuance notations and the duration-nuance notations) that facilitate easy learning, accurate pronunciation, and enhanced language preservation.

### Process Overview

The teaching process utilizes a series of well-defined steps that guide the learner through the identification of sounds associated with each Cherokee character. These steps include:

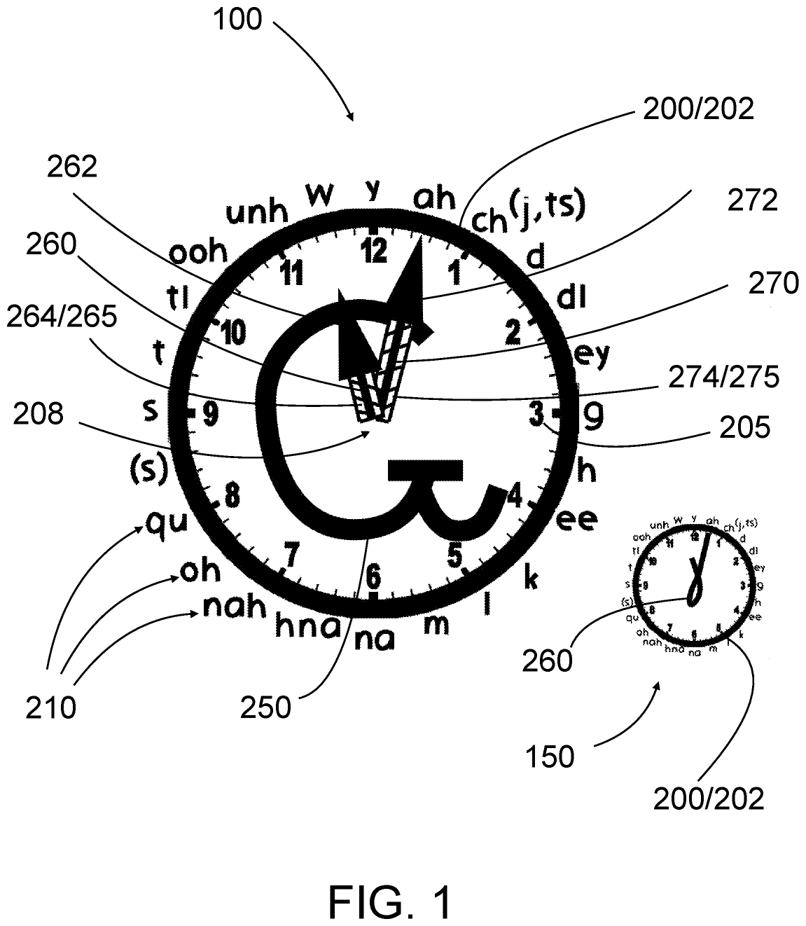

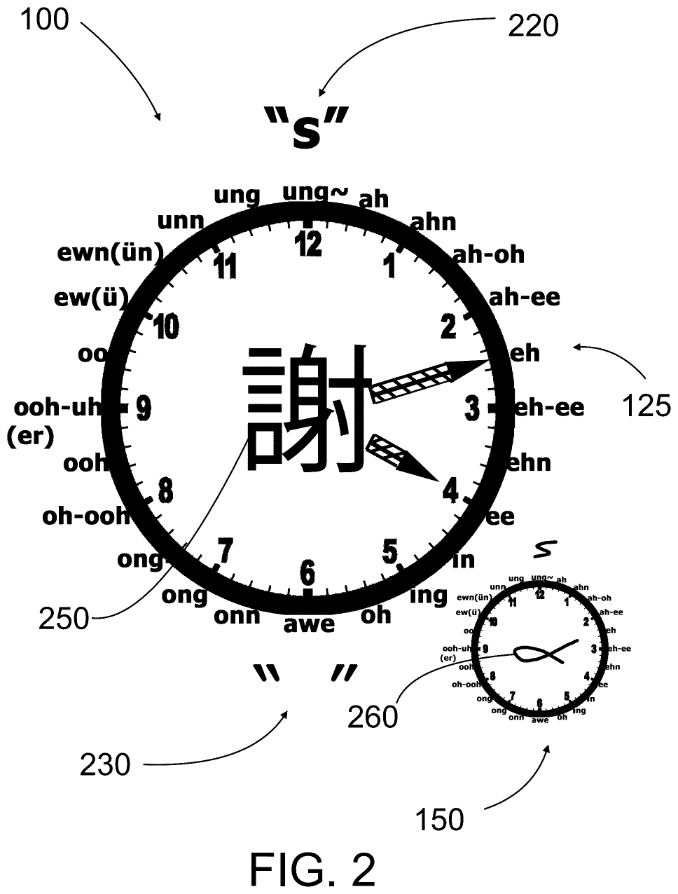

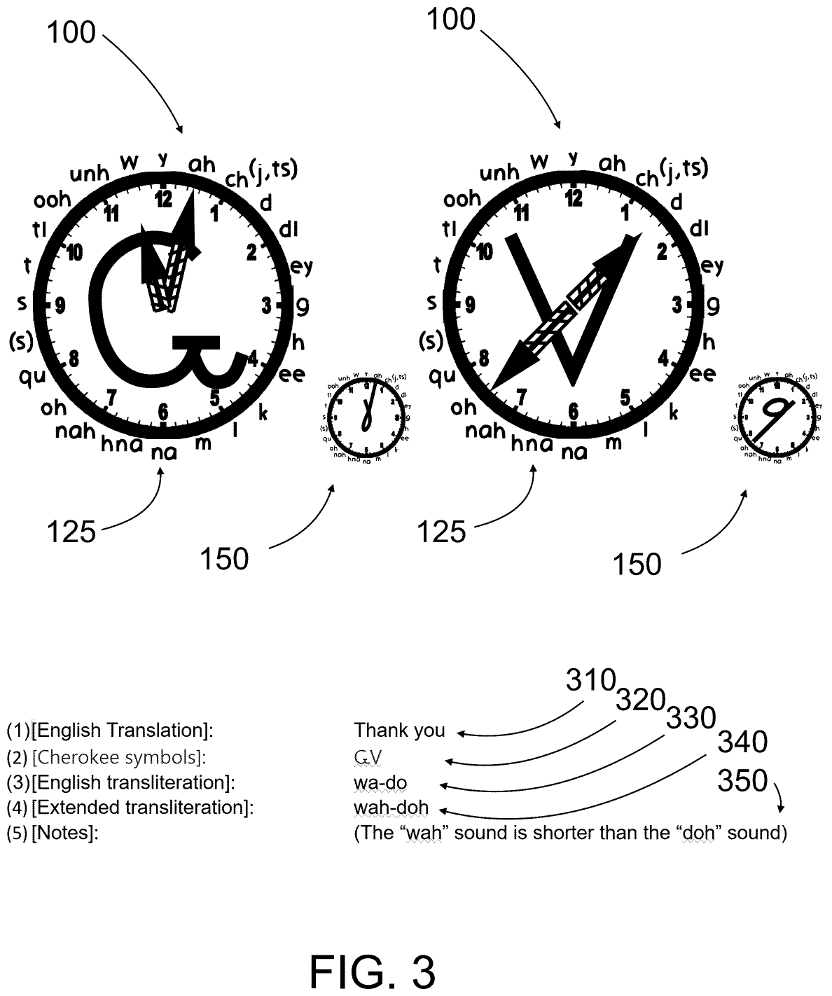

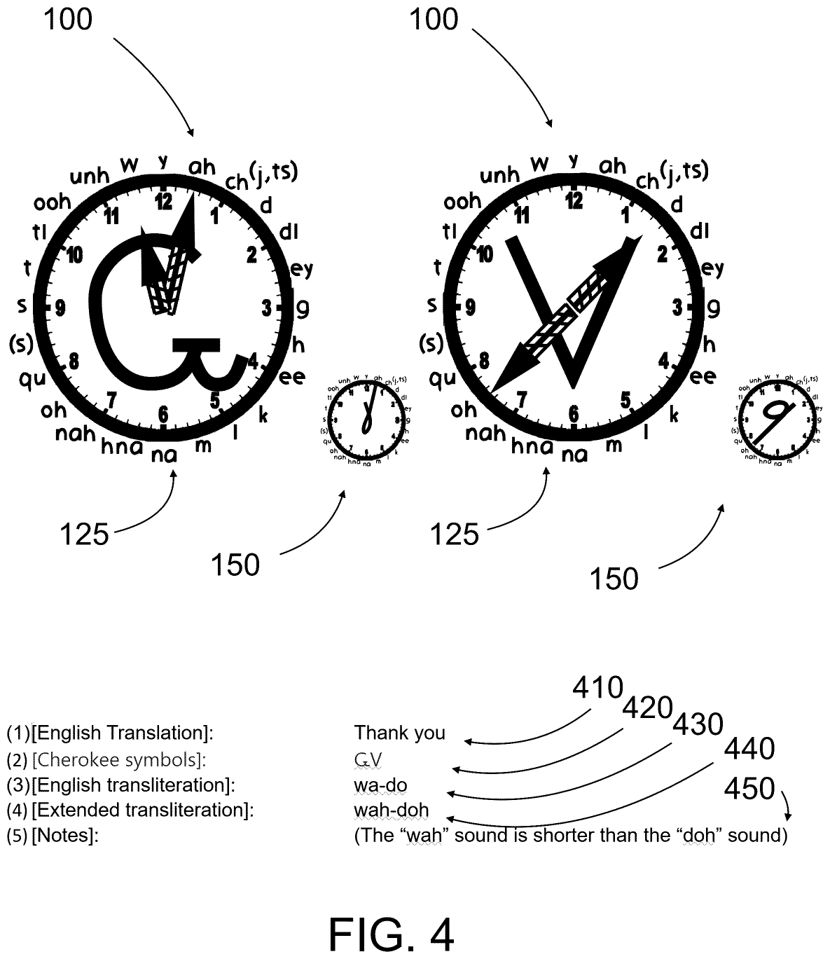

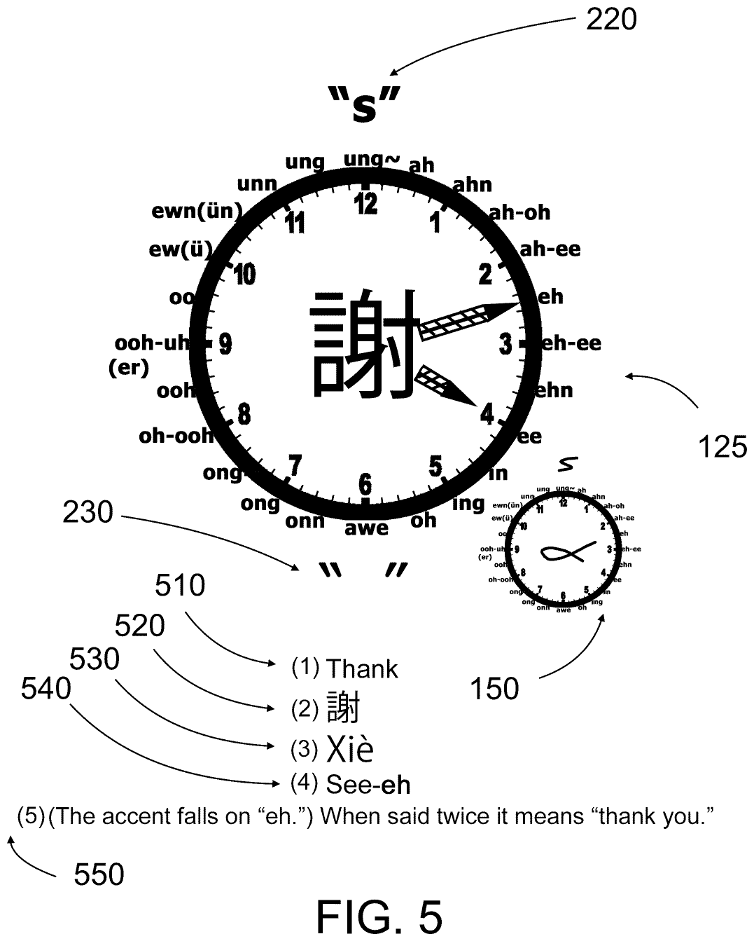

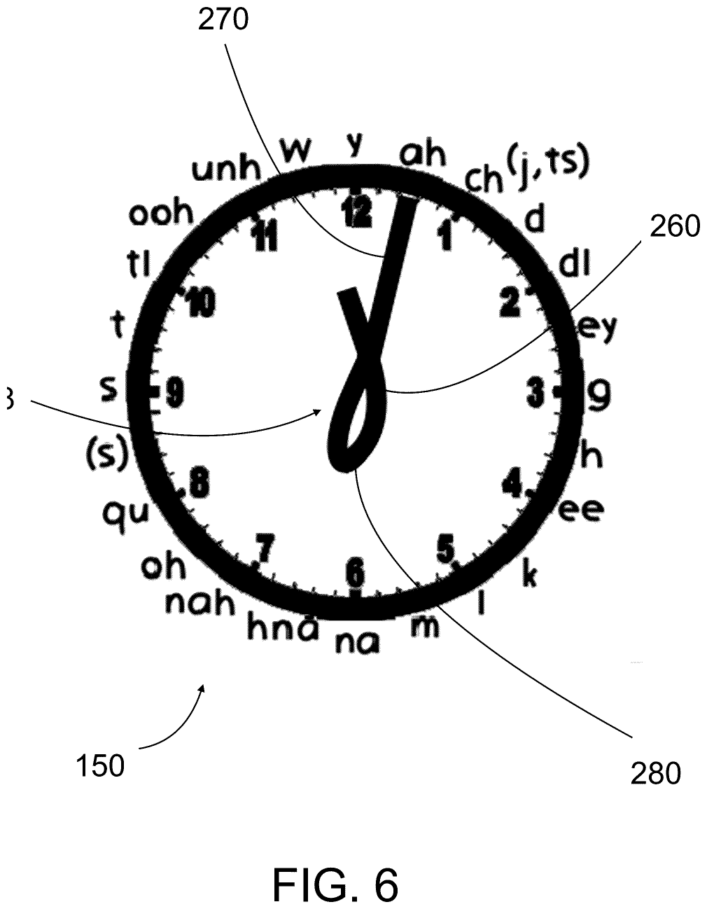

Visual Cue Recognition: The learner observes the green-highlighted short line within the clock-face character (see FIG. 1, Reference Character 102) to identify the first sound associated with the Cherokee character (see FIG. 1, Reference Character 103).

Secondary Sound Identification: The learner identifies the second sound associated with the Cherokee character (see FIG. 1, Reference Character 105) by observing the red-highlighted long line within the clock-face design (see FIG. 1, Reference Character 104).

Sound Combination and Pronunciation: Combining the two sounds identified in steps 1 and 2, the learner pronounces the basic sounds of the Cherokee character correctly.

Tone/Melodic Pattern Practice: The learner practices the tone/melodic patterns and syllable durations associated with the Cherokee characters and as indicated by language nuance notations (the tonal-nuances and the duration-nuances) using specialized numerals and hyphens to achieve accurate pronunciation as the characters are combined to form words and phrases; see FIG. 3, Reference Character 304; also see FIG. 3, under the notes area for Reference Character 305 which shows a larger display of the Cherokee word written as, “Pronounced: wah(2-) doh(1--)” while using the extended transliteration with the nuance notations, and under the above and still within the general “Notes” section as identified by the Reference Character 305, an image of musical notation is displayed on a music sheet which identifies the tonal nuances/melody for this Cherokee word's tones and syllable lengths. For the above referenced word “wah(2-) doh(1--)”, we see that the numeral “2” represents a higher tone/note for the first syllable while the second syllable's tone/note falls to a “1”; we also see that the first syllable has a short duration (as noted by having only one hyphen) and the second syllable is spoken/held twice as long as the first syllable (as designated by having two hyphens.)

Reiteration for Word and Phrase Formation: Steps 1-3 are repeated for each Cherokee character in a word or phrase in association with the language nuance notations (the tonal-nuance notations and the duration-nuance notations), ensuring comprehensive understanding and pronunciation.

Authentic Language Pronunciation: The learner correctly pronounces the word or phrase in the authentic Cherokee language, solidifying their grasp of the language's nuances.

### Precision and Versatility

The precision of the clock-face character design ensures that each Cherokee character has a unique and easily distinguishable representation, eliminating any confusion and promoting accurate pronunciation. This precision extends to the positioning of the clock hands, which are strategically placed to indicate the correct sequence of sounds for each character. Therefore, no two clock-face fonts share the exact same short and long hand configurations; this makes each Cherokee character have a unique configuration which extends to the correlating shorthand font design characters (functioning analogous to lowercase letters in an alphabet.) For example, in FIG. 1, the short line (see FIG. 1, Reference Character 102) and the long line (see FIG. 1, Reference Character 104) uniquely represent the time on a clock as “11:02” (or more specifically, “the short hand points to the 57 minute mark while the long hand points to the 2 minute mark”) based upon these line positions.

The versatility of the invention lies in its adaptability to various syllabaries and languages. The basic principles of the clock-face character design and the associated teaching process can be seamlessly applied to different languages, making it a valuable tool for promoting language diversity and preservation.

### Examples from Testing

The following are successful results after a person was given basic instructions on how to use the clock-face font designs and then tested on correctly matching the correct syllabary sounds associated with 86 Cherokee syllabary characters by being presented with clock-face designs within 3 feet of a computer screen (which displayed clock-face letters, one at a time, which measured 3 inches by 4 inches on the computer screen as displayed from the inventor's Primer book.)

An over-50-year-old female whose first language was Spanish with no prior exposure to the Cherokee Syllabary or language achieved 100% accuracy in 6 minutes and 24 seconds by using the present invention's clock-face font designs during the test.

An adult in his 20's with severe Autism who was able to correctly identify 5 out of 5 (100% of the tested Cherokee Syllabary characters) correct associated sounds for the first five corresponding Cherokee Syllabary vowel characters by using the present invention's clock-face font designs during the test which lasted 28 seconds (though fewer characters overall were tested due to the limited attention span of this individual who has Severe Autism.)

A 60-year-old male who has Asperger's syndrome and color vision deficiency (who has difficulty seeing the color blue) achieved 100% accuracy in 7 minutes and 16 seconds by using the present invention's clock-face font designs during the test.

A 55-year-old male who is considered to be “neuro-typical” and who has color vision deficiency (who has difficulty seeing the color blue) achieved 100% accuracy in 6 minutes and 42 seconds by using the present invention's clock-face font designs during the test.

### Benefits and Applications

The benefits of the present invention are multifaceted:

Enhanced Language Learning: The visual and intuitive nature of the clock-face characters facilitates easier and more effective language learning.

Accurate Pronunciation: The precise design and teaching process ensure accurate pronunciation of Cherokee characters, enhancing fluency and comprehension.

Language Preservation: The invention's ability to promote language learning and accurate pronunciation contributes to the preservation of endangered languages like Cherokee.

The applications of the invention extend beyond language teaching:

Vocabulary Expansion: The invention can be used to create new words based on the melodic patterns of the Cherokee language, enriching the vocabulary.

Existing Word Enhancement: The invention can be applied to enhance existing words for which the melodic pattern may have been lost or is otherwise unknown.

Database and Dictionary Enhancement: The invention's potential to identify melodic patterns can contribute to the enhancement of language databases and dictionaries.

### Conclusion

The present invention, encompassing a unique clock-face character font-styled design and an effective teaching process, revolutionizes language teaching and preservation. The present invention's ease of use, precision, and versatility make it a valuable tool for promoting language diversity and ensuring the continued vitality of endangered languages.

Herrick et al. (2015), referenced the problems and challenges for the current population of speakers and learners not having clear intuitions about Cherokee tones (Herrick et al., 2015). These problems and challenges have been resolved by the present invention, as the present invention accomplishes what no other invention has done prior to the existence of the present invention by intertwining the authentic sounds and nuances (the tonal-nuances and the duration-nuances) of the tonal Cherokee language into an integrated font-styled design with nuance notations (the invention's written form of the authentic Cherokee language) that removes the need for any student/learner to require having intuition about how to speak the authentic form of the Cherokee language.

### Additional Details

In the book “Making Dictionaries: Preserving Indigenous Languages of the Americas” by William Frawley, Kenneth C. Hill, and Pamela Munro there are discussions about how to approach the issue of Cherokee tones (Frawley et al., 2002a).

Munro discusses the importance of representing tones in Cherokee dictionaries (Frawley et al., 2002a). The new clock-face-styled font design (the new clock-face font) and one or more visually measurable language nuance indicators (the tonal-nuances and the duration-nuances which are the notation indicators which represent the correct phonetic sounds and nuances originally taught by Native Cherokee Speakers and incorporated into this invention) outlined herein advances this concept like no other system, process, or dictionary has done in the past, whereas the present invention combines the transliteration and Cherokee syllabary into one font design which has never before been invented. Munro argues that tones are an essential part of the Cherokee language and that they must be accurately represented in dictionaries in order for them to be useful for speakers and learners of the language (Frawley et al., 2002a). The present invention outlined herein accurately identifies and shows (notates) the correct intonations and nuances (the tonal-nuances and the duration-nuances) for how to correctly speak the authentic Cherokee language and documents this in written form at an extensive level that has not yet been attempted or achieved prior to the existence of the present invention.

Munro also discusses the challenges of representing tones in dictionaries and she notes that there is no single, universally accepted system for representing tones and that different dictionaries use different systems (Frawley et al., 2002a). Not having a sufficient universal system in the past has been the challenge. Even though various word lists have been compiled and dictionaries have been updated, the systems (prior to this invention) have not fully identified and shown (notated) a full representation of the tones for all of the syllables in Cherokee words, and also these resources have not presented a visual method for identifying the syllable lengths for every syllable in Cherokee words. In contrast, the present invention does visually identify and visually show (notate) both the tone changes and syllable lengths for all Cherokee syllables in all Cherokee words.

The present invention uses language nuance indicators (the tonal-nuances and the duration-nuances) which are comprised of an original numeric font (integrated with musical-notation-styled dots attached to numerals 1-4, specifically referenced as the tonal-nuances) and also the use of a hyphen (used to represent the duration-nuances) which is based on a visual representation of the rising and falling tones and the visual lengths of syllables. This meets the criteria for being a novel invention which can also become the new standard for presenting the authentic Cherokee language in written form in order to make dictionaries “user-friendly” for people of all ages and circumstances, ranging from those on the Autism Spectrum to those who are neuro-typical, young to old, Cherokee citizens and non-citizens, etc. The present invention represents one standard system which includes considerations for the needs of various people from various backgrounds and circumstances, especially in reference to accurately conveying tone patterns and syllable lengths to avoid confusion. Munroe referenced that confusion exists between current sources of Cherokee words and pronunciations (Frawley et al., 2002a). This invention specifically identifies the language nuances (the tonal-nuances and the duration-nuances) and thereby removes confusion and provides a clear understanding of how the targeted language is designed to be accurately and authentically pronounced.

Also found within “Making Dictionaries: Preserving Indigenous Languages of the Americas”, Rhodes argues that dictionaries should represent multiple assertions and grammatical constructions in order to accurately reflect the way that languages are used in real-world contexts (Frawley et al., 2002a). By using the Clock-face letters described in this book, all variations and explanations of Cherokee words (such as the primary forms of verb conjugations) can be displayed and pronounced very quickly, which is designed to increase the probability of achieving language acquisition.

The Cherokee tonal patterns/melodies were discovered (by using this invention) as having common “base tonal patterns” from which other Cherokee words emulate (either in full or in part.) The discovery of these common tonal patterns are being compiled in a database by the inventor. These same base patterns can be applied to older words (words which may no longer have any known tonal patterns) as well as used to create and build new words in the present and future (by using these base tonal patterns as a template to build these new words.)

While there are many challenges and opportunities of representing Cherokee tones and other features of Indigenous languages in dictionaries, the end result needs to be that there is an agreement in using an all-purpose standard which can fully and accurately represent the authentic Cherokee language in a written and compiled form, which includes but is not limited to visually documenting and showing the tonal/melodic pattern representations of the authentic Cherokee language.

The present invention is an essential resource for anyone who is interested in the accurate documentation, preservation, and conveyance of the authentic Cherokee language.

When a person (who is unfamiliar with the Cherokee language) is only shown the written form of the Cherokee Syllabary characters, it is impossible to know what the correct associated sounds are for each of the Cherokee characters/syllables, because the Cherokee sounds do not match how an English speaker would otherwise pronounce these characters (many of which are misleading because the Cherokee Syllabary characters often resemble Latin letters.)

If an English-speaking person (who has never before become familiar with the Cherokee language) were to see a series of Cherokee Syllabary characters, it is highly improbable that he or she would be able to correctly guess the correct sounds which correlate with each Cherokee character/symbol. For example, the correct sounds associated with each of the following characters would be difficult, if not impossible, to ascertain if any such person were trying to learn the sounds of the Cherokee Syllabary without having any prior knowledge or a special invention to guide him or her when presented the following characters:

“D, T, A, J, E, W, G, h, Z, 4, b, V, L, and P.”

The examples provided below show how the appearance of the Cherokee symbols do not correlate with what English-speaking people would normally associate as being the correct sounds to use, and therefore we need to bridge the gap of understanding by using the present invention. Take for example:

The Cherokee character which looks like “D”, is pronounced “ah”;

The Cherokee character which looks like “T”, is pronounced “ey”;

The Cherokee character which looks like “i”, is a nasal sound “unh”;

The Cherokee character which looks like “A”, can be pronounced as “goh” or “koh”;

The Cherokee character which looks like “J”, can be pronounced as “gooh” or “kooh”;

The Cherokee character which looks like “E”, can be pronounced as a nasal “gunh” or

“kunh”;

The Cherokee character which looks like “W”, is pronounced “lah”;

The Cherokee character which looks like “G”, is pronounced “nah”;

The Cherokee character which looks like “h”, is pronounced “nee”;

The Cherokee character which looks like “Z”, is pronounced “noh”;

The Cherokee character which looks like “4”, is pronounced “sey”;

The Cherokee character which looks like “b”, is pronounced “see”;

The Cherokee character which looks like “V”, is pronounced “doh” or “toh”;

The Cherokee character which looks like “L”, is pronounced “tley” or “dley”;

The Cherokee character which looks like “P”, is pronounced as a nasal “tlunh” or “dlunh”;

A reasonable person can see that the above characters could cause an English-speaking student/learner to have confusion when trying to determine and learn the correct sounds associated with the Cherokee Syllabary characters. The remaining Cherokee Syllabary characters also offer no indication as to what the correct Cherokee pronunciation is for each character (the Cherokee Syllabary has a total of 86 characters when including all of the original Cherokee Syllabary characters.) To avoid further confusion in learning the Cherokee Syllabary due to the Cherokee characters not giving any visual indication in reference to which sounds might be associated with each Cherokee character, the inventor has created the present invention to resolve this circumstance. The present invention provides a solution which identifies the tonal patterns/melodies, syllable sounds, syllable lengths, intonation patterns and characteristics of the Cherokee language, and therefore the present invention identifies and teaches the authentically represented Cherokee language through this invention. This invention enables the use of these specialized font designs and language nuance notations (tonal-nuance notations and duration-nuance notations) designs to convey and teach the fullness of the authentic Cherokee language.

A valuable resource for teaching any language is the use of an exhaustive compilation of vocabulary words, therefore the need for this user-friendly invention to be made available in the form of a compiled dictionary to accurately and visually represent the tonal patterns/tonal references, syllable sound nuances, syllable length nuances, intonation patterns, and characteristics of the authentically represented Cherokee language within the dictionary entries is a reasonable and worthwhile goal to achieve in the near future for the benefit of the citizens of the Cherokee Nation.

A popular resource for learning the Cherokee vocabulary is Durbin Feeling's 1975 Cherokee Dictionary (Feeling, 1975). It is widely regarded as the standard reference for the Cherokee language. However, while Feeling did use notation references for some syllable lengths and most tones, Feeling's process differs greatly from the present invention in the following ways: Feeling chose not to show notations for the last syllable of Cherokee words, he chose not to show notations for the middle length/duration syllable, he did not use a notation system which would visually show the rising and falling of tones, he did not use a notation system which showed the visual representation of the duration of syllables (which would otherwise show consecutive symbols to represent lengths and duration), he did not integrate each of the transliterations/syllable sounds with each of the Cherokee Syllabary characters into one font, and he did not invent a shorthand version of the syllabary, which is all based upon Durbin Feeling's descriptions and representations in his 1975 dictionary (Feeling, 1975); however, in contrast, the present invention does all of the above thereby making the present invention unique and far more advanced than the above referenced standard from Durbin Feeling.

According to BARD: “A Dictionary of the Cherokee Language” compiled by J. T. Alexander in 1971 contains approximately 15,000 entries. It is considered a valuable resource for Cherokee language learners and scholars, but it is not as comprehensive as Durbin Feeling's 1975 Cherokee Dictionary, which contains approximately 20,000 entries. (Bard, 2023).

While the book compiled by J. T. Alexander is considered to be a “list of vocabulary” instead of a standard “dictionary” (a dictionary would normally contain more extensive information and details), and while Durbin Feeling's 1975 Cherokee Dictionary had substantially more information which more closely resembles what would be found in a standard dictionary (which has been periodically updated), it remains true that the information that is provided in the above books have not provided information to the extent and degree of visual representation through a specially designed font and language nuance (tonal-nuance and duration-nuance) notation system that this invention outlines herein.

Additionally, this invention is tailored to the learning preferences of logically-oriented individuals (such as individuals with Autism Spectrum Disorder/ASD, individuals with Asperger's Syndrome, individual with high IQ, and individuals with certain logic-oriented personality traits.) Data from the US Department of Education show that the number of students with autism receiving special education services has increased dramatically in recent years. In the 2000-2001 school year, there were approximately 350,000 students with autism receiving special education services. By the 2020-2021 school year, this number had increased to over 900,000 (U.S. Department of Education, 2023).

The Cherokee Nation's newspaper reported that Principal Chief Chuck Hoskin Jr. and Deputy Chief Bryan Warner announced several new steps the tribe is taking to better address autism diagnosis and treatment among Cherokee Nation citizens, including the creation of a Task Force on the Cherokee Nation Autism Initiative. (Cherokee Phoenix, 2023)

Based upon the increased percentages of people who have and are diagnosed with having various forms of autism (including Asperger's Syndrome, which is considered a part of the Autism Spectrum category), this invention has been designed to work well with this population. This invention is specifically designed to cater to the logic-based learning preferences of individuals (such as those who have with Asperger's Syndrome, a demographic for which the inventor is well acquainted), utilizing consistent and predictable patterns within the font designs.

Wilma Mankiller, the first female Principal Chief of the Cherokee Nation promoted the preservation of endangered languages when she said, “A language is a road map, a guide to the way a culture thinks.” (Mankiller, 1995)

While there have been several movements to preserve endangered tonal languages in writing and in databases without simultaneously documenting the nuances (the tonal-nuances and the duration-nuances) of these tonal languages, the result is that the authentic tonal language still becomes extinct without implementing an easier process which notates all language nuances (to include the tonal-nuances and the duration-nuances). Once the fullness of a language has become extinct, the living culture dies with it. The inventor defines the phrases “authentic tonal” and “authentic Cherokee language” herein as relating to the complete characteristics of a tonal language, including the tonal patterns/melodies, syllable sounds, syllable lengths, and intonation patterns and characteristics of the tonal language.

According to the Cherokee Nation, the Cherokee Nation Language Department Executive Director Howard Paden stated that the Cherokee Nation's Cherokee Language Master/Apprentice Program graduated seven students in March 2023. The program's first graduating class occurred in 2016, and since then, 44 conversational, second-language Cherokee speakers have graduated. (Paden, 2023)

Therefore, the Cherokee Nation has had a program since 2016 which offers limited enrollment and a 2-year commitment for this immersion program which averages approximately a handful of graduates each year.

While the efforts of the Cherokee Nation are extraordinary in trying to revitalize and preserve the Cherokee language, this program and the number of graduates do not reflect a high percentage of adding fluent Cherokee speakers who are able to speak the authentically spoken Cherokee language compared with our approximately 450,000 Cherokee citizens who cannot do this.

In order to preserve the Cherokee Nation's language, heritage, and culture, we must resolve the obstacles we face at the source. Before we can achieve having 100% of our Cherokee citizens become authentic Cherokee language speakers, Cherokee citizens need to have the confidence to speak the authentic Cherokee language in their homes with their families so that future generations will be raised as Native Cherokee Speakers. Before families will speak in their homes, they must first have learned or be in the process of learning how to speak the authentic Cherokee language as individuals. Cherokee citizens have the right to use the Cherokee language at home, at school, at work, and in the community. Before speaking the authentic Cherokee language as individuals, there must be an ongoing training process that is easy to use and which promotes ease of access to learning the correct pronunciations, tones/melodies, syllable sounds, syllable lengths, intonations and other nuances of the Cherokee language which results in being able to speak the authentic Cherokee language. If the instruction is not designed and implemented by using a simple and easy design and process, then this threatens the longevity of the motivation for any student/learner which then threatens the longevity of the endangered language.

According to a study by the University of Cambridge, the probability of continuing to learn a language is higher if it is easy to learn (Jiang et al., 2015).

Based upon the above referenced study results, it would logically appear that if the language is perceived to be too difficult to learn, then this perception (that the process would be a difficult one) would appear to prevent students and learners from continuing to learn how to speak the authentic Cherokee language; this appears to be the case for the citizens of the Cherokee Nation (based on the percentage of fluent Cherokee speakers within the Cherokee Nation.)

Before we can design a language program that is easy for Cherokee citizens, we must first consider how to design the program in light of our Cherokee citizen's primary language in America (which may also be their first learned language): English.

Based on the study “The role of transfer in language learning” by Ellis, R. C. (2008), this study provides a comprehensive overview of the role of “transfer” in language learning. Ellis defines transfer as the “use of previously acquired knowledge or skills from one language (the L1) in the learning of another language (the L2)” (p. 46). Part of the argument given is that the direction and magnitude of transfer effects are influenced by a number of factors, including the similarity between the L1 and the L2 (Ellis, 2008).

In order to design a fully effective language-learning program that is easy to use (“user-friendly”) it is advantageous to use a process which bridges the gap between the targeted language (the authentic Cherokee language) and the student/learner (the Native English-speaking Cherokee citizen.)

In “The effects of native language phonology on the acquisition of second language phonology” by Flege, J. E. (1995), this study reviews the research on the effects of native language phonology on the acquisition of second language phonology. Flege argues that native language phonology can have both positive and negative effects on second language phonology acquisition. Positive effects can occur when the phonological systems of the two languages are similar, while negative effects can occur when they are different (Flege, 1995).

An effective teaching process for teaching the approximate 450,000 Cherokee citizens how to read and speak the authentic Cherokee language must incorporate the English language within the processes/steps for learning the Cherokee language in order to become fully effective.

In “The effects of native language morphology on the acquisition of second language morphology” by Bybee, J. L. (2006), this study reviews the research on the effects of native language morphology on the acquisition of second language morphology. Bybee argues that native language morphology can have a significant impact on the acquisition of second language morphology. She also argues that the direction and magnitude of transfer effects are influenced by a number of factors, including the similarity between the L1 and the L2, the learner's proficiency in both languages, and the type of morphological feature being acquired (Bybee, 2006).

In “The effects of native language syntax on the acquisition of second language syntax” by Hakuta, K. (1987), this study reviews the research on the effects of native language syntax on the acquisition of second language syntax. Hakuta argues that native language syntax can have a significant impact on the acquisition of second language syntax. She also argues that the direction and magnitude of transfer effects are influenced by a number of factors, including the similarity between the L1 and the L2, the learner's proficiency in both languages, and the type of syntactic feature being acquired (Hakuta, 1987).

The research shows that the more a language program integrates a person's first language into the steps and processes of instruction, the more likely that person is to learn the second language. The closer the association, the better the results.

English, to a native English speaker, is fairly easy to read and speak, which should be an obvious observation. However, because it is easy for a person to speak his or her primary and/or first language, it is often easy to overlook the role and effect that having English as one's primary or first language can have when learning a second language, especially a language which has a Class IV level of difficulty for learning such as is true of the Cherokee language (languages with a level IV difficulty rating from the Foreign Service Institute are considered to be the most challenging for English speakers to learn) which is at the same level of difficulty in learning for Arabic, Chinese, Japanese, Korean, Finnish, and other languages (U.S. Department of State, n.d.)

It might be easier for a Native English-speaker to dismiss a new and novel invention based upon the apparent simplicity of a design used for the process of learning a new language, especially if and when that invention integrates one's familiarity with the English language into what would otherwise appear to be presented in an obvious manner. However, the above studies indicate that incorporating one's primary/native language into a language learning process for learning a second language should be done if one wants to gain the greatest results toward language acquisition.

The present invention is a new and novel idea for language learning and ultimately for language revitalization and preservation. While current methods of teaching the Cherokee language separate the Cherokee symbols (“Syllabary”) from the English version of representing the sounds (“transliteration”), the present invention does something novel which has never before been done until now: This invention integrates the “transliteration” into the “Syllabary.” This is arguably the newest and most original design in the history of the written Cherokee language (perhaps even in the history of all written Native American languages) since Sequoyah first invented the Cherokee Syllabary.

The font designs aspect of this invention (the new/original clock-face-styled font design and the new/original and visually measurable language nuance notation designs) substantially resolves the above problems and obstacles.

Sequoyah (the inventors 7^{th} cousin, 7 times removed) invented the Cherokee Syllabary to preserve the history, culture, and language of the Cherokee people. The inventor of this present invention has created this invention to revitalize the authentic Cherokee language and preserve the Cherokee history, culture for his fellow Cherokee citizens as well as for himself as a Cherokee citizen.

As a Cherokee citizen, the inventor upholds tribal values and respects Cherokee traditions. He carries forward the responsibility from his ancestors, as well as his moral obligation, to preserve the Cherokee history, culture and authentic Cherokee language through this invention.

In order to inspire over 450,000 Cherokee citizens to read and speak the Cherokee language toward becoming fluent and using the Cherokee language in all aspects of their lives, this endeavor calls for a novel innovation which can be perceived by the student/learner as being easy and simple to use (“user-friendly”), yet at the same time it must have a process which can uniquely teach the sounds associated with the Cherokee symbols; the present invention does this.

The present invention has enabled a Spanish speaker with no prior Cherokee language exposure to correctly identify all Cherokee syllabary sounds in under seven minutes. Similarly, an individual with Severe Autism could identify all associated sounds for the tested Cherokee characters. The present invention is versatile enough to be used by a wide range of people and is designed to be successfully used by all Cherokee Citizens (approximately 450,000 people) with the intention of saving the Cherokee language from extinction. The clock-face font-styled design and intuitive layout of this invention contribute to the ease of use and accurate identification of authentic Cherokee sounds which makes the present invention user-friendly and easy to use.

The present invention is versatile and can be implemented for use with other languages being threatened with extinction.

This invention adapts to the needs for each language, therefore, the visual cues within the clock-face letters can similarly be applied to other languages. The present invention can be used and applied for all levels of difficulty for various languages.

It should be noted that, while this method uses color-coding for the lines within the clock-face, this method can still be used by learners who have color vision deficiency, because sufficient indicators (black arrow-heads used in a manner which identify the correct phonetic sounds) are recognizably displayed on the clock-face letters (referencing the black arrow-heads and phonetic references) which can be clearly seen by learners who have color vision deficiency.

For each new language being taught/learned using the present invention, each of the targeted (original) letters (symbols, characters, glyphs) are displayed within the clock-face which can then correctly be associated with the specific phonetic sound(s) for each letter.

This present invention incorporates (visually measurable) identifiable indicators (specialized numerals 1-4 and hyphens) concerning the nuances (the tonal-nuances and the duration-nuances) of each language's sounds which also includes tonal references and nuance indications for the Cherokee language. Additional notes/instructions will be added to five lines underneath the clock-face occurrences. The way that this invention employs distinct symbols to capture the subtle variations in pronunciation (including tonal/melodic patterns and syllable lengths) is by using the tonal references and nuance (tonal-nuance and duration-nuance) indicators of specialized numerals 1-4 and hyphens to visually show the rising and falling of tones and the duration of syllable lengths (similar to documenting musical notations.) The Cherokee language is tonal language which has tone/melody patterns intertwined within the sounds of the language fluctuations.

A valuable resource for teaching any language is the use of a complied set of vocabulary words, therefore the need for this user-friendly invention to be made available in the form of a compiled dictionary (using words from a compiled database) to accurately represent the tonal/melodic patterns of the authentic Cherokee language within the dictionary entries is a reasonable and worthwhile goal to achieve in the near future for the benefit of the citizens of the Cherokee Nation.

The present invention is a new and novel method for teaching the Cherokee language that integrates transliteration into the Syllabary. This is a revolutionary idea that has never been implemented in the history of the Cherokee Nation. This approach is designed to make it easier for learners to connect the two languages and to reduce the perception of the Cherokee language as being difficult to learn, whether or not a person has a highly logical or analytical mind.

For beginners, notes in the Primer books will give simplified versions and references of tone patterns/melodies and syllable length indicators, while more advanced educational materials, such as dictionaries, will show the tone patterns/melodies and syllable lengths in specific detail for each entry, using the special language nuance (tonal-nuance and duration-nuance) notation indicators by using specialized numerals 1-4 and hyphens for students/learners who are at intermediate or advanced levels of learning the Cherokee language (for intermediate and advanced notation representations, see the compiled database example in FIG. 4.)

For example, in reference to FIG. 3, the Primer e-book shows the following as represented by the Reference Characters in FIG. 3:

Reference Character 301: The first line underneath each (Cherokee) clock-face identifies the English translation of the letters, words, and phrases from the targeted language.

Reference Character 302: The second line identifies the targeted language's unique letters (symbols, characters, glyphs) in order to separately identify the structure of each unique letter (symbol, character, glyph) separately from the overall clock-face letter (in this example, “thank you” is written using the Cherokee letters on line 2 which appear visually similar to the capital English letters “G” and “V” though the Cherokee symbols are completely unrelated to English letters);

Reference Character 303: The third line displays the standard English transliteration of the targeted language. For beginners who are learning the Cherokee language the standard transliteration does not always provide the learner with sufficient information toward identifying the correct pronunciations of the Cherokee language. For example, the standard transliteration represented by the English letter “v” is a nasal sound, not an English “v” sound. However, this transliteration is included on the third line to familiarize the learner with the current standard transliteration for the targeted language, per the example on the third line.

Reference Character 304: The fourth line identifies more precise sounds by using the extended transliteration used within this invention which uses English letters, potentially along with bold text to specifically identify variances such as identifying soft versus hard sounds such as identifying a softer “j” sound versus a harder “ch” sound since both of these sounds can be represented by the same Cherokee letter/character in the Cherokee syllabary.

Reference Character 305: The fifth line is reserved for additional brief descriptions as needed in reference to unique information or language nuances (the tonal-nuances and the duration-nuances). In the Cherokee in the FIG. 3 example, the typed notes on the fifth line indicate the following:

(The “wah” sound is shorter than the “doh” sound.) This description is used in the Primer references the syllable length for the beginner, whereas the language nuance (the tonal-nuance and the duration-nuance) indicators are designed for use with the intermediate and advanced students/learners.

The database and dictionary entries show Cherokee words in the form of “wa(2-) do(1--)”; see examples shown in the compiled database as shown in FIG. 4. It should be noted that the Design Patent application by the same inventor shows the fonts for this invention which shows the numeral design for numerals 1-4. This tone pattern design incorporates lines which resemble a music score, and a “note-shaped dot” which is used to visually show the rising up and falling down on the music score as the number becomes higher or lower (visually indicating the changes in tone pattern/melody); see FIG. 4. The hyphens represent the syllable duration in a visual pattern (representing durations of short, medium, or long based upon using one, two, or three hyphens.) This is how the tonal references and nuance (the tonal-nuance and the duration-nuance) indicators identify the tone patterns/melodies and syllable lengths for intermediate and advanced students/learners.

This invention is not limited to being taught within one training format but can also be used in combinations with various/other training formats (such as within e-Books, apps, printed books, dictionaries, flashcards, placemats, websites, videos, clock-face fonts, workbooks, overhead projectors, online apps, etc.; the clock-face designs can be physically embodied as a printed poster, a digital display on a tablet or computer screen, or even a tactile surface with raised symbols for learners with visual impairments.) Therefore, it can also be used to create primers and various language lessons/training materials for all levels and ages of learners; the present invention is versatile because the invention's clock-face font-styled design and language nuance indicators (tonal-nuance and duration-nuance indicators) are the focus of what teaches the learner the intonations (using the visual clock-face and cues for reading and speaking the correctly spoken sounds.

### Shorthand-Cursive-Style Characters

Additionally, for the advanced learner, this invention includes a “shorthand-cursive-style” reference for each letter (symbol, character, glyph) in the lower right hand corner of each clock-face letter which functions analogous to lowercase letters in an alphabet and follows the simple logic established and specifically based upon the highlighted lines, direction of lines, and angle (created by the combined lines within the clock-face for each letter.) For example, for the Cherokee language the clock-face letter's “shorthand-cursive-style” symbol includes either a single line (representing a single vowel sound or a single “s” sound) or a combination of two lines (representing a consonant sound plus a vowel sound) is based upon using the patterns created by the “short, green-highlighted lines” combined with the “long, red-highlighted lines” for each letter; this shorthand-cursive-style reference often includes a “loop” (which crosses through or near the center-point of the clock-face at both the beginning and ending of the loop and attaches the short line with the longer line), and this loop is designed to make writing each shorthand-cursive-style symbol easier (versus writing abrupt/jagged angles between the two lines.) This method is specifically designed for languages which primarily use a combination of more than one sound for a given letter (symbol, character, glyph), which is the circumstance for the Cherokee language examples provided for reference (see “FIG. 1.”) The shorthand-cursive-style form of the targeted letter follows the patterns created by the larger clock-face's lines and angles, beginning with the short line and progressing to the longer line (see “FIG. 1.”)

While certain languages may pose a learning challenge for English speakers due to their seemingly complex or intricate writing systems, this invention introduces a novel approach that simplifies letter representation. By combining clock-face symbols, line and arrow cues, and phonetic references, this invention creates a unique and logically structured system for each letter, transforming otherwise challenging characters into user-friendly representations.

The Cherokee language often has elaborate designs for several letters while other Cherokee letters are simple in appearance but are also similar to other Cherokee letters (only having subtle differences in their appearances), therefore this invention specifically identifies a logical clock-face and pattern which is unique for each thereby enhancing (and potentially advancing) the Cherokee language into having a logical pattern of associations between the symbols and phonetic sounds.

The shorthand-cursive-style portion of this invention (which can be used for various targeted languages and syllabary) follows the same logical pattern used for each (larger) clock-face letter. This invention uses the pattern of short and long lines from the clock-face letters to create the shorthand-cursive-style form of writing.

The fonts created from the clock-face letters most commonly use black, however, when font technology advances to allow multiple designated colors, then this font will use that technology.

### Application for Other Languages

This invention was originally designed to contribute toward saving the Cherokee language (a Class IV level of difficulty for learning a language), however, the applications for the present invention can be used for all languages.

The inventor of the present invention appreciates that his relative (the inventor of the Cherokee Syllabary, Sequoyah) was deeply invested in the promotion and preservation of the Cherokee language for his generation. Chief Chuck Hoskin Jr. has introduced the concept that this century is our “Great Cherokee Century” both in the present and for our future generations. The inventor of the present invention also appreciates the need for a current, updated, and enhanced version and presentation of the Cherokee Syllabary and language which is designed to exponentially expand the use of the Cherokee language within this current Great Cherokee Century and also for generations which will follow. This same concept is intended to be applied toward all languages for enhanced learning and preservation of culture and language.

One of the applications for the present invention by the inventor is that, first and foremost, it is designed to be logically and systematically developed for dying languages and then for remaining languages while ensuring that the same standards of this invention are used as designed by the inventor to maintain the integrity of the steps, principles, and goals of this invention for each new language.

The present invention's conception was originally invented during the process of the inventor's attempt to learn the Cherokee language as an adult. This invention was originally applied toward the Cherokee language by logically and systematically combining the authentic phonetic sounds (as learned from a Native Cherokee speaker) with the corresponding Cherokee letters. The Cherokee syllabary does not otherwise appear to have a logical association between the Cherokee symbols, characters, and their sounds, and therefore the inventor deduced that this invention was necessary to help save the Cherokee language (while at the same time honoring-Sequoyah's original design of the Cherokee syllabary. The present invention has the potential to become the ideal logical learning method for the native-English speaker because it precisely and immediately identifies the appropriate sounds associated with each letter. This invention was also designed to include potential applications for the languages of the other four Nations of the Five Civilized Tribes: the Chickisaws, the Choctaws, the Creeks (Muscogee), and the Seminoles.

This invention could be applied to other dying tonal languages making this invention versatile, having the potential to revitalize other endangered languages.

A description of the process for applying this invention for each new language consists of the basic steps of:

Step 1: Identify all of the basic sounds that create the syllables for the characters of the targeted language. This step involves analyzing the phonology of the language to identify the distinct sounds that make up its syllables and characters. This may involve consulting with Native Speakers, linguists, or language experts who are familiar with the language.

Step 2: Transliterate these sounds into English and list them in alphabetic order. Transliteration involves representing the sounds of a language using the letters of another language, in this case, English. This helps to make the sounds more accessible to a wider audience and provides a common reference point for comparison.

Step 3: Equally disperse these transliterated sounds around the clock-face design in (English) alphabetic order. This step involves arranging the transliterated sounds around the clock face in a logical and organized manner. The alphabetic order based on the English language provides a consistent and easily recognizable pattern.

Step 4: Add each glyph/character/symbol of the targeted language one at a time inside the clock-face font design, to typically identify the first sound with the short-green-highlighted line/arrow, and then identify the second sound with the long-red-highlighted line/arrow (languages with additional sounds will be addressed on a case by case circumstance.) This step involves incorporating the unique characters or symbols of the targeted language into the clock face font. The highlighted lines and arrows provide visual cues to indicate the correct order and pronunciation of the sounds associated with each character.

Step 5: Create the shorthand symbol based upon the lines in each of the clock-face fonts. This step involves developing a shorthand symbol that captures the essence of the clock face font for each character. The shorthand symbol provides a simplified representation of the language's sounds and symbols, facilitating faster learning and recognition, and also providing an additional (or brand new) written form of each language.

For example, in FIG. 2, we see the Cherokee word “wado” (“thank you”) displayed inside of the clock-face design. These two Cherokee characters look very similar to a capital “G” and a capital “V” in English, though they represent completely different sounds. The first Cherokee character represents the “wah” sound, and the second Cherokee character represents the “doh” sound. Each of these sounds are broken down further. The clock-face arrows (beginning with the short line and ending with the longer line) show the learner to begin with the “w” sound and then combine it with the “ah” sound for this character to create the full syllable sound of “wah.” This same technique is applied to the second Cherokee character, whereas the short line points to the “d” sound and the long line points to the “oh” sound so that the combined sounds represent the full syllable sound of “doh” for this character. When fully using all of the techniques for this invention, this invention teaches a student/learner how to speak the accurate language nuances (the tonal-nuances and the duration-nuances) for each language entirely through the written form, thus accurately preserving all of the nuances of any language.

This invention has first been applied to the Cherokee language. The Cherokee Nation is in a potential position of helping to facilitate this inventions use for other dying languages, beginning with the tonal Native American languages which are at the highest risk of becoming extinct. This invention adapts to the needs of each language by using various visual references to identify the nuances (the tonal-nuances and the duration-nuances) of each language, making it easier for the student/learner to learn and practice speaking these dying languages. Accomplishing the task of making a second language easier to learn is a key element in learning that second language (Jiang et al., 2015). This invention is easy to use and incorporates all of the necessary visual ingredients to be successfully used by students/learners toward reading, speaking, and learning a second language.

The inventor (a native English speaker) can understand the learning needs and perspectives of other native English speakers who are learning a foreign language or unknown language such as tonal Native American languages. In reference to the Cherokee Language, this invention allows for all Cherokee Citizens to feel valued as equal Cherokee speakers who can learn the correct phonetic sounds and nuances (the tonal-nuances and the duration-nuances) associated with the Cherokee letters and language (sounds and nuances which are originally taught by native Cherokee speakers and incorporated into this invention-), though now in written form.)

This invention uses processes for presenting information to the learner in a way that maximizes the English-speaker's existing knowledge of the English language to allow immediate reading and speaking of the letters and words.

This invention is presented to the learner in a way that promotes increased familiarity toward increased confidence.

The learner does not need to cross-reference other resources to verify the correct pronunciation or implementation while using this invention because the sounds and nuances (the tonal-nuances and the duration-nuances) from native speakers of the targeted language are identified and given language nuance notations in written form. Learners can access and view video instructions which can also include audio pronunciations after presenting the visual clock-faces for each letter along with additional lines of information) which can be viewed by individuals or by groups video lesson training (whether accessed online or through DVD's.) Short video or audio segments would work well as an addition to an online dictionary which could include either voice examples or tone pattern/melody examples.

This invention may also include formats which are accessible by a computer such as a flash drive, a CD-ROM, a DVD, a web-accessible site which provides access to training videos and other materials, etc.

The present invention provides a number of advantages over previous methods for learning a new language. This invention's use of clock-face letters provides a visual representation of the sounds associated with each letter, making it easier for learners to associate the sounds with the symbols. For instance, in the Cherokee language, the clock-face letter for the syllable ‘wa’ has short, green-highlighted lines pointing to the ‘w’ sound and long, red-highlighted lines pointing to the ‘ah’ sound (see FIG. 1.)

The learner has the potential to immediately read and speak a new language, which then promotes the learner to have increased inspiration and motivation toward continued progress at a pace comfortable for the learner.

While using the present invention, people can practice reading and speaking a new language as fast as they can read the clock-face letters.

As the learner progresses, the “clock-face font” can be used for continued learning. The learner can type documents for personal training/practice, and for writing to others. The Cherokee clock-face font uses the same keyboard layout as the standard Cherokee Nation keyboard layout with the exception that this invention includes all 86 characters of the Cherokee Syllabary. Similar clock-face fonts can be made for other languages.

The additional notes added under the clock-face letters, words, and phrases contribute toward added confirmation of accuracy, allowing the learner to proceed with confidence and quickly identify the correctly pronounced and ordered letters, words, and phrases in the new language. The computer-readable mediums that may be used to store (and distribute) the present invention and method referenced above make it easy to provide access to and distribute the method to a wide audience. For example, easy access and distribution of this invention is advantageous for the approximate 450,000 Cherokee citizens, most who have not yet learned the Cherokee language. This invention is ideal for English-speaking people who want to learn to read, speak, and preserve various languages, including the Cherokee language. This invention is intended to be used to learn and preserve several languages (it is first intended to be applied toward saving the dying/rarely spoken languages and then to be implemented for other languages.)

This invention's method and system of teaching a language's syllabary, vocabulary, and phrases is user-friendly. The visual representations of the syllabary promotes a process which allows learners to be able to immediately read and speak the correctly ordered sounds of the letters in the syllabary for each new language. This invention provides learners with a unique user-friendly method of practicing the correct pronunciations of the syllabary.

The present invention contributes toward resolving a common dilemma of how to save and preserve dying languages, such as the dilemma experienced by modern-day Cherokee Citizens of how to preserve and advance the Cherokee language. There are estimated to be approximately 2,000 fluent Cherokee speakers remaining (Hoskin, 2023). The present invention was designed to further advance and preserve the Cherokee language and culture in this modern era.

In reference to the Cherokee Nation, the present invention is designed to further contribute toward bringing the Cherokee Nation together as one group of people who share a fluently spoken language among the Cherokee people to further unify the Cherokee citizens.

The present invention is: designed to retain students/learners (due to being user-friendly) and is anticipated to result in higher percentages of people completing new language programs by using the present invention for learning new languages; identifies and associates the correct phonetic sounds of the targeted language's letters in advance (within each clock-face letter) for immediate use by the learner (removing any prerequisite to memorize the phonetic sounds/syllabary and nuances of a new language); is designed to be simple and easy to use which makes it effective for people of all levels and ages toward increasing language proficiency; is a valuable tool toward promoting and preserving the culture, heritage, and traditions of the Cherokee Nation within this Great Cherokee Century; is designed to contribute toward the mission to complete resurgence and restoration of the Cherokee language, culture, and heritage as well as being similarly applied toward other languages; can also be used for learning other syllabary and languages for the least spoken or least written Native American languages such as the Ojibwe language, and to clarify and enhance the understanding of the pronunciations of the Sioux language, as well as use this invention to preserve unwritten Native American languages such as the Chemehuevi, the Wintu-Nomlaki, the Tolowa, the Patwin, and the Pawnee languages. The shorthand-cursive-style form of this invention can be used within each language to reach the same goal: Immediate reading and speaking of the new languages being learned to enhance the learning and preservation of such languages.

The shorthand-cursive-style form of the present invention can also be used within each language creating new letters and writing systems for each language and also making it a standardized invention which can potentially preserve all languages using this invention. The shorthand symbols are developed by capturing the essence of the clock-face font for each Cherokee Syllabary character. In FIG. 1, we see how the shorthand symbol (located in the lower-right-hand corner of the overall font design) has a short and long line which are in the same positions as the lines/arrows displayed within the larger clock-face which represents the Cherokee Syllabary character. Both of these clock-face designs/symbols have short and long lines which uniquely represent the time on a clock as “11:02” (or more specifically, “the short hand points to the 57 minute mark while the long hand points to the 2 minute mark”) based upon these line positions, and therefore the shorthand symbol's lines provide a duplicated and simplified representation of the language's sounds and symbols as based upon the larger clock-face design, facilitating faster learning and recognition, and also providing an additional (or brand new) written form of each language.

With the present invention, potentially all languages can be read and spoken relatively quickly and is designed for the person who wants to quickly read and speak a new language by using the tonal indicators within each clock-face letter as described herein.

It should be noted that the claims in a patent application do not have to be limited to the specific details that are described in the application. A person with ordinary skill in the art can make changes to the invention without affecting the scope of the claims. All embodiments of the invention that are covered by the claims are protected by the patent.

The present invention, having a clock-face-styled font design which includes English letters as a reference showing how to correctly pronounce the Cherokee characters, is a new and useful article of manufacture because it has a specific function, namely to help teach people how to pronounce the correct sounds associated with each Cherokee character, and therefore this indicates that this invention is also a patentable manufacture.

Wilma Mankiller used the words “language” and “culture” in her statement, “A language is a road map, a guide to the way a culture thinks” (Mankiller, 1995). This invention is not only useful in preserving languages, but it is also instrumental in preserving cultures as well.

Each clock-face font design is similar to a roadmap for how to correctly speak each Cherokee character. The directional lines are clearly marked to identify the correct destinations to travel toward in the correct order of travel. The English language is used to incorporate the transliterations into each clock-face font design. The nuance indicators (the tonal-nuance indicators, comprised of specialized numerals 1-4, and the duration-nuance indicators using hyphens) further identify how to correctly speak the Cherokee language. The occasional orange font identifies the characters which have “softer” phonetic consonant sounds (such as using a softer “gw” sound versus a “qu” sound.) The overall design of the clock-face font with the language nuance indicators is a self-contained invention which documents how a person can emulate the sounds and nuances of any language, making the present invention both highly versatile and valuable in preserving languages and cultures. This invention can be used by wide demographics of the human population (such as children, adults, or people with learning disabilities) because of it is easy to use. The clock-face letters and shorthand-cursive-style characters provide a unique and effective way to learn the sounds and symbols of a new language, therefore making a second language easier to learn.

The present invention can impact language education and cultural understanding by making language learning more accessible and enjoyable; it has the potential to increase the number of people who are able to communicate across cultures, fostering greater understanding and collaboration among different communities; it is designed not only to teach and preserve second languages and cultures, but it is also designed to help restore the dignity of the people who are associated with the each language, culture, and history. Therefore, helping to restore a people's history and culture through language learning helps to restore the people and helps toward healing their wounds; a language restored and revitalized represents a people who are restored and revitilized.

The Cherokee people have always been peaceful and cheerful. The present invention is paving a new roadmap for the Cherokee citizens which is in contrast to what our Cherokee ancestors were forced to endure from the Trail of Tears. The present invention is designed to restore Cherokee citizens back to the original culture of cheerfully speaking the authentic Cherokee language on a new trail of revitalization and restoration: “The Trail of Cheers.” The present invention is designed to teach the Cherokee language in an easy way so that Cherokee citizens can once again speak with authentic Cherokee voices using joyful cheers in the Cherokee language as Cherokee ancestors did long ago.

### The Present Invention Versus Prior Art

REPRESENTATION OF NUANCES: The present invention uses a visual system of clock-face font designs and nuance indicators to represent tonal indicators and duration indicators, however, prior art relies on various forms of notations which are inconsistent (not standardized between the different types of notation methods), are difficult to read, do not display the notations in a visually measurable way, and which can be complex and difficult to understand (see FIG. 5.)

CLARITY AND CONSISTENCY: The present invention provides a clear and consistent visual representation of nuances, making it easier for students/learners to understand it and apply it toward learning the targeted language, however, prior art methods often lack consistency and can be difficult to interpret.

ADAPTABILITY: The present invention can be adapted to represent the nuances of a wide range of languages while simultaneously creating a new writing system for each language (the shorthand font design), however, prior art methods are often limited to specific languages or language families.

LEARNING EFFECTIVENESS: The present invention has the potential to improve language learning outcomes by providing a more intuitive and engaging way to learn nuances, however, prior art methods may not be as effective in promoting nuance (tonal and syllable duration) learning.

### Strengths of Present Invention

Intuitive and accessible: The clock-face design and visual indicators for tone and duration make learning Cherokee more intuitive and accessible, especially for learners with different learning styles or preferences.

Comprehensive representation: The system accurately captures the nuances of spoken Cherokee, including tone, syllable length, and even “softer” consonant sounds.

Dual-font approach: The inclusion of both clock-face fonts and shorthand fonts provides flexibility and caters to different learning stages or preferences.

Preservation and documentation: The system serves as a valuable tool for documenting and preserving the authentic tonal heritage of the Cherokee language.

Cultural significance: This invention goes beyond language learning; it fosters cultural identity and empowers the Cherokee community to reclaim their linguistic heritage.

### Potential Applications of the Present Invention

Language learning: This invention's system can be used in classrooms, language learning apps, and self-study programs to make Cherokee learning more engaging and effective.

Dictionary creation: The clock-face fonts and nuance notations can be incorporated into dictionaries to provide a more comprehensive and accurate representation of spoken Cherokee.

Standardized writing system: The shorthand font has the potential to become a new standardized writing system for Cherokee, promoting literacy and communication.

Other endangered languages: The system's adaptability can be applied to revitalize other endangered languages with similar tonal and syllable-based features.

### REFERENCES

### Books

Bybee, J. L. (2006). Second language acquisition and morphosyntax. In Morphologies and acquisition (pp. 31-68). Cambridge University Press.
Ellis, R. C. (2008). The role of transfer in language learning. In The handbook of language acquisition (pp. 467-521). Routledge.
Feeling, Durbin, and William Pulte. Cherokee-English Dictionary (pp. vii-355). Cherokee Nation of Oklahoma, 1975.
Flege, J. E. (1995). The effects of native language phonology on the acquisition of second language phonology. In Phonology and second language acquisition (pp. 1-77). Oxford University Press.
Frawley, W., Hill, K. C., & Munro, P. (Eds.). (2002a). Making Dictionaries: Preserving Indigenous Languages of the Americas. University of California Press.
Hakuta, K. (1987). Pragmatic aspects of language learning and use. In Language learning (pp. 327-391). Cambridge University Press.
Hinton, L., & Hale, K. L. (Eds.). (2001). The green book of language revitalization in practice. San Diego: Academic Press.
Levitin, D. J., & Menon, V. (2003). The effect of music on language processing: A review of the literature. Psychological Bulletin, 129 (1), 43-60.
Mankiller, W. (1995). Mankiller: A Cherokee chief speaks out. St. Martin's Press.

### Journal Articles

Cole, G. R., & Hagner, T. (2013). Colour constancy for colour-blind observers. Journal of vision, 13 (11), 1-14.
Herrick, D., Berardo, M., Feeling, D., Hirata-Edds, T., & Peter, L. (2015). Collaborative Documentation and Revitalization of Cherokee Tone. Language Documentation and Conservation, 9, 12-31.
Jiang, H., Weber, N., & Ramscar, M. (2015). The influence of perceived language difficulty on language learning outcomes. Language Learning, 65(3), 431-452.
Paden, H. (2023 Mar. 16). Cherokee Nation Language Department to graduate seven fluent Cherokee speakers. Cherokee Nation. Retrieved from https://indianz.com/News/2022/08/22/chuck-hoskin-cherokee-nation-launches-new-program-for-cherokee-speakers/

### Government Reports

U.S. Department of Education. (2023). 34^{th} Annual Report to Congress on the Implementation of the Individuals with Disabilities Education Act. Washington, D.C.: U.S. Department of Education.

### Oral Presentation

Hoskin, C. (2023 Nov. 18). Principal Chief of the Cherokee Nation [Oral presentation]. Desert Cherokees At-Large Meeting, Tucson, Arizona.

### Provisional Patent

Suzuki, M. d. S., Hamilton, D. J., & Suzuki, E. M. (2013). Methods and systems for transcribing or transliterating to an iconophonological orthography. U.S. Provisional Patent Application No. 2013/0191115 A1, filed Nov. 3, 2011 and published Jul. 25, 2013.

### Webpages

Bard. (2023 Nov. 20). Durbin Feeling's 1975 Cherokee Dictionary vs. “Dictionary of the Cherokee Language” compiled by J. T. Alexander in 1971. Bard: Large Language Model from Google AI. Retrieved from https://chat.openai.com/chat

Cherokee Nation Language Department. (Aug. 4, 2023). Cherokee Language. Retrieved from https://language.cherokee.org/chr/: https://language.cherokee.org/chr/Cherokee Phoenix. (2023 Aug. 22). CN announces new efforts to address autism diagnosis, treatment. [Cherokee Phoenix]. Retrieved from https://www.cherokeephoenix.org/services/cn-announces-new-efforts-to-address-autism-diagnosis-treatment/article_c4fd7e98-d4b2-11ed-8056-4b8860e3ee77.html
U.S. Department of State. (n.d.). Language Difficulty Ranking. Retrieved from https://www.state.gov/foreign-language-training/

1. (canceled)

2. (canceled)

3. (canceled)

4. (canceled)

5. (canceled)

6. (canceled)

7. A method to read and utter syllables of a targeted language by creating specific and unique phonetic clock-faced letters representing each syllable of the targeted language and designed to be displayed on a written, digital or tactile medium, the method comprising:
(a) identifying all basic sounds that create syllables of the targeted language;
(b) transliterating the identified basic sounds into English letters and listing the transliterated basic sounds in alphabetic order;
(c) equally dispersing and displaying the transliterated basic sounds around an analog clock-face in English alphabetic order;
(d) identifying a syllable of the targeted language;
(e) displaying a letter representing the identified syllable of the targeted language within the analog clock-face;
(f) identifying a first sound of the identified syllable of the targeted language;
(g) displaying drawing a short line with a first end and a second end,
(i) where the first end of the short line points to the transliterated basic sound around the analog clock-face that corresponds to the first sound of the identified syllable,
(ii) where the second end of the short line points towards the center of the analog clock-face; and
(h) displaying an arrow to the first end of the short line that points to the transliterated basic sound around the analog clock-face that corresponds to the first sound of the identified syllable.

8. The method described in claim 7, further comprising:
(a) identifying a second sound of the identified syllable of the targeted language;
(b) displaying a long line with a first end and a second end,
(i) where the first end of the long line points to the transliterated basic sound around the analog clock-face that corresponds to the second sound of the identified syllable, and
(ii) where the second end of the long line points towards the center of the analog clock-face; and
(c) displaying an arrow to the first end of the long line that points to the transliterated basic sound around the analog clock-face that corresponds to the second sound of the identified syllable.

9. The method described in claim 8,
(a) where the short line is highlighted with a first color, and
(b) where the long line is highlighted with a second color.

10. The method described in claim 8, further comprising:
(a) performing the English transliteration of the identified syllable of the targeted language in an extended manner,
(i) where bold text is added to identify stressed syllables,
(ii) where long vowels versus short vowels are identified and differentiated, and
(iii) where soft versus hard sounds are identified.

11. The method described in claim 8, further comprising:
(a) displaying a first line of information below the analog clock-face, where the first line of information identifies the English translation of the letter representing the identified syllable of the targeted language;
(b) displaying a second line of information below the analog clock-face, where the second line of information identifies the letter representing the identified syllable of the targeted language within the analog clock-face;
(c) displaying a third line of information below the analog clock-face, where the third line of information displays a standard English transliteration of the letter representing the identified syllable of the targeted language;
(d) displaying a fourth line of information below the analog clock-face;
(i) where the fourth line of information displays an extended English transliteration of the letter representing the identified syllable of the targeted language,
(ii) where bold text is added to identify stressed syllables,
(iii) where long vowels versus short vowels are identified and differentiated, and
(iv) where soft versus hard sounds are identified; and
(e) displaying a fifth line of information below the analog clock-face, where the fifth line of information displays additional brief descriptions in reference to accents syllable length and other language nuances.

12. The method described in claim 8, (a) where the analog clock-face is in the shape of a circle.

13. The method described in claim 8, further comprising:
(a) identifying three sounds of the identified syllable of the targeted language;
(i) where the three sounds comprise an initial sound, the first sound, and the second sound, and
(b)
(c) displaying the transliterated basic sound of the initial sound displayed above the analog clock-face.

14. A short-hand method to read and utter syllables of a targeted language by creating specific and unique phonetic clock-faced letters representing each syllable of the targeted language and designed to be displayed on a written, digital or tactile medium, the method comprising:
(a) identifying all basic sounds that create syllables of the targeted language;
(b) transliterating the identified basic sounds into English letters and listing the transliterated basic sounds in alphabetic order;
(c) equally dispersing and displaying the transliterated basic sounds around an analog clock-face in English alphabetic order;
(d) identifying a syllable of the targeted language;
(e) displaying a letter representing the identified syllable of the targeted language within the analog clock-face;
(f) identifying a first sound of the identified syllable of the targeted language; and
(g) displaying a short line with a first end and a second end,
(i) where the first end of the short line points to the transliterated basic sound around the analog clock-face that corresponds to the first sound of the identified syllable,
(ii) where the second end of the short line points towards the center of the analog clock-face.

15. The short-hand method described in claim 14, further comprising:
(a) identifying a second sound of the identified syllable of the targeted language;
(b) displaying a long line with a first end and a second end,
(i) where the first end of the long line points to the transliterated basic sound around the analog clock-face that corresponds to the second sound of the identified syllable, and
(ii) where the second end of the long line points towards the center of the analog clock-face; and
(c) connecting the second end of short line to the second end of the long line with a loop.

16. The short-hand method described in claim 15, further comprising:
(a) performing the English transliteration of the identified syllable of the targeted language in an extended manner,
(i) where bold text is added to identify stressed syllables,
(ii) where long vowels versus short vowels are identified and differentiated, and
(iii) where soft versus hard sounds are identified.

17. The short-hand method described in claim 16, further comprising:
(a) displaying a first line of information below the analog clock-face, where the first line of information identifies the English translation of the letter representing the identified syllable of the targeted language;
(b) displaying a second line of information below the analog clock-face, where the second line of information identifies the letter representing the identified syllable of the targeted language within the analog clock-face;
(c) displaying a third line of information below the analog clock-face, where the third line of information displays a standard English transliteration of the letter representing the identified syllable of the targeted language;
(d) displaying a fourth line of information below the analog clock-face,
(i) where the fourth line of information displays an extended English transliteration of the letter representing the identified syllable of the targeted language,
(ii) where bold text is added to identify stressed syllables,
(iii) where long vowels versus short vowels are identified and differentiated, and
(iv) where soft versus hard sounds are identified; and
(e) displaying a fifth line of information below the analog clock-face, where the fifth line of information displays additional brief descriptions in reference to accents, syllable length and other language nuances.

18. The short-hand method described in claim 15,
(a) where the analog clock-face is in the shape of a circle.

19. The short-hand method described in claim 15, further comprising:
(a) identifying three sounds of the identified syllable of the targeted language;
(i) where the three sounds comprise an initial sound, the first sound, and the second sound; and
(b)
(c) displaying the transliterated basic sound of the initial sound displayed above the analog clock-face.

20. The method described in claim 7, further comprising:
(a) equally dispersing and displaying the transliterated basic sounds around a second analog clock-face in English alphabetic order;
(b) displaying a short line with a first end and a second end,
(i) where the first end of the short line points to the transliterated basic sound around the second analog clock-face that corresponds to the first sound of the identified syllable, and
(ii) where the second end of the short line points towards the center of the second analog clock-face.

21. The method described in claim 8, further comprising:
(a) equally dispersing and displaying the transliterated basic sounds around a second analog clock-face in English alphabetic order;
(b) displaying a short line with a first end and a second end,
(i) where the first end of the short line points to the transliterated basic sound around the second analog clock-face that corresponds to the first sound of the identified syllable, and
(ii) where the second end of the short line points towards the center of the second analog clock-face;
(c) displaying a long line with a first end and a second end,
(i) where the first end of the long line points to the transliterated basic sound around the second analog clock-face that corresponds to the second sound of the identified syllable, and
(ii) where the second end of the long line points towards the center of the second analog clock-face; and
(d) connecting the second end of short line to the second end of the long line with a loop.

22. The method described in claim 21,
(a) where the short line of the analog clock-face is highlighted with a first color,
(b) where the long line of the analog clock-face is highlighted with a second color,
(c) where the short line of the second analog clock-face is highlighted with a first color and
(d) where the long line of the second analog clock-face is highlighted with a second color.

23. The method described in claim 21, further comprising:
(a) identifying three sounds of the identified syllable of the targeted language,
(i) where the three sounds comprise an initial sound, the first sound, and the second sound; and
(b)
(c) displaying the transliterated basic sound of the initial sound displayed above the analog clock-face.

24. The method described in claim 11,
(a) wherein the fifth line of information below the analog clock-face further displays memory cues.

25. The method described in claim 17,
(a) wherein the fifth line of information below the analog clock-face further displays memory cues.
